(19) United States
(12) Patent Application Publication
(10) Pub. No.: US 2026/0124925 A1
(43) Pub. Date: May 7, 2026

(54) Battery Management System and Vehicle

(71) Applicant: Robert Bosch GmbH, Stuttgart (DE)

(72) Inventor: Xiaofei Qiu, Suzhou (CN)

(21) Appl. No.: 19/376,978

(22) Filed: Nov. 2, 2025

(30) Foreign Application Priority Data
Nov. 4, 2024 (CN) 2024 1156 2145.0

(51) Int. Cl. B60L 3/04; B60L 50/60; H01M 10/42

(52) U.S. Cl. CPC B60L 3/04; B60L 50/60; H01M 10/425; H01M 2010/4271; H01M 2220/20

(57) ABSTRACT

A battery management system and a vehicle are disclosed. The battery management system includes (i) a first terminal connected to a high-voltage battery, (ii) a second terminal connected to an electronic control unit, (iii) an electrical isolation circuit configured to receive a first current from the electronic control unit via the second terminal, (iv) a current sensing unit configured to sense a second current output by the electrical isolation circuit and generate a disconnect signal in response to the second current exceeding a first threshold value, and (v) a battery disconnect unit configured to disconnect the high-voltage battery from a load connected to the high-voltage battery in response to the disconnect signal. The electrical isolation circuit includes a photoelectric coupling circuit.

This application claims priority under 35 U.S.C. § 119 to application no. CN 2024 1156 2145.0, filed on Nov. 4, 2024 in China, the disclosure of which is incorporated herein by reference in its entirety.

The present disclosure relates to the technical field of battery management, and in particular to a battery management system and a vehicle comprising the battery management system.

### BACKGROUND

In electric vehicles (EVs), hybrid electric vehicles (HEVs), and plug-in HEVs (PHEVs), a high-voltage (HV) battery powers the electric motor. A crash may damage the high-voltage battery, potentially causing a short circuit and a vehicle fire. To prevent fires in a crash, a battery disconnect airbag is often used to disconnect the high-voltage battery network. However, such airbags are expensive, and repairing them after a crash is also costly.

To address these design flaws, a solution has been proposed that uses a differential current amplifier in the battery management system (BMS) to detect the firing current as an input and disconnect the high-voltage battery. However, in this solution, the electronic control unit (ECU) is affected by the differential current amplifier in the battery management system.

### SUMMARY

The present disclosure provides a battery management system and a vehicle comprising such a battery management system to prevent a differential current amplifier in the battery management system from affecting an electronic control unit.

Examples of the present disclosure provide a battery management system comprising: a first terminal connected to a high-voltage battery; a second terminal connected to an electronic control unit; an electrical isolation circuit configured to receive a first current from the electronic control unit via the second terminal; a current sensing unit configured to sense a second current output by the electrical isolation circuit and generate a disconnect signal in response to the second current exceeding a first threshold value; and a battery disconnect unit configured to disconnect the high-voltage battery from a load connected to the high-voltage battery in response to the disconnect signal, wherein the electrical isolation circuit comprises a photoelectric coupling circuit.

Examples of the present disclosure further provide a vehicle, comprising an electronic control unit, a high-voltage battery, and a battery management system according to an example of the present disclosure.

### BRIEF DESCRIPTION OF THE DRAWINGS

FIG. 1 is a schematic block diagram of a battery management system used in related art for sensing firing current;

FIG. 2 is a schematic circuit diagram of a battery management system used in related art for sensing firing current;

FIG. 3 is a schematic block diagram of a battery management system according to an example of the present disclosure;

FIG. 4 is a schematic circuit diagram of an electrical isolation circuit in a battery management system according to an example of the present disclosure.

Throughout the several drawings, corresponding reference signs indicate corresponding parts. The elements shown are not necessarily drawn to scale. The configurations depicted are merely examples and should not be construed as limiting the scope of the present disclosure in any way.

### DETAILED DESCRIPTION

The accompanying drawings of the examples of the present disclosure are provided to offer a further understanding of the examples and constitute a part of the Specification. Together with the detailed examples, they are used to explain the present disclosure and are not intended to limit the present disclosure. The above and other features and advantages will become more readily apparent to those skilled in the art through the description of the detailed examples with reference to the accompanying drawings.

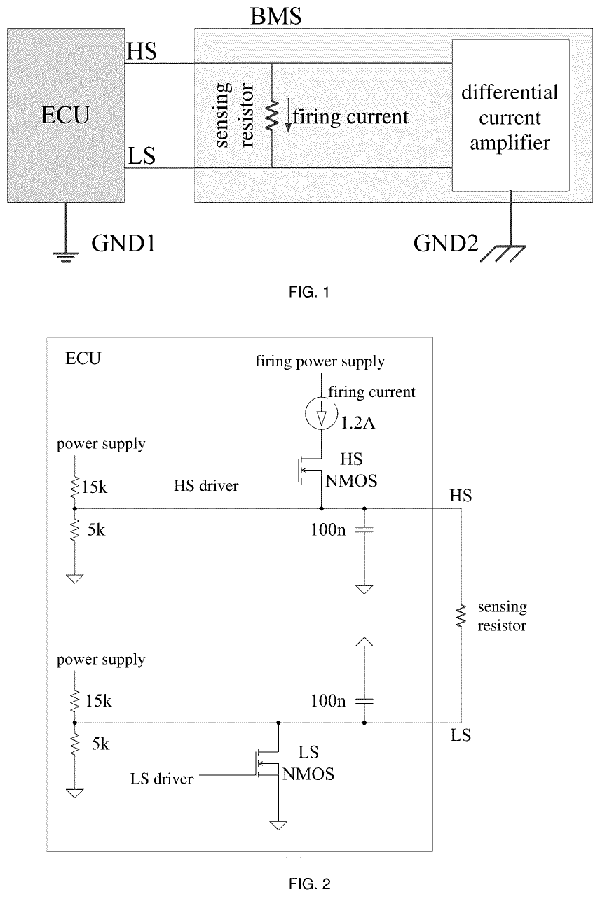

FIG. 1 is a schematic block diagram of a battery management system sensing firing current in the related art. FIG. 2 is a schematic circuit diagram of a battery management system sensing firing current in the related art.

As shown in FIGS. 1 and 2, the sensing resistor in the battery management system is connected between the high side (HS) and the low side (LS) of the electronic control unit, and the differential current amplifier in the battery management system senses the firing current flowing through the sensing resistor. Since the differential current amplifier in the battery management system is directly electrically connected to the electronic control unit, the differential current amplifier will affect the electronic control unit. In addition, there is a ground deviation between the ground GND1 of the electronic control unit and the ground GND2 of the differential current amplifier, which will cause current injection from or to the electronic control unit. Since the input circuit of the battery management system is a high-impedance circuit, the electronic control unit is easily affected by electromagnetic compatibility (EMC), such as bulk current injection (BCI).

To address the above design deficiencies, the present disclosure proposes a battery management system.

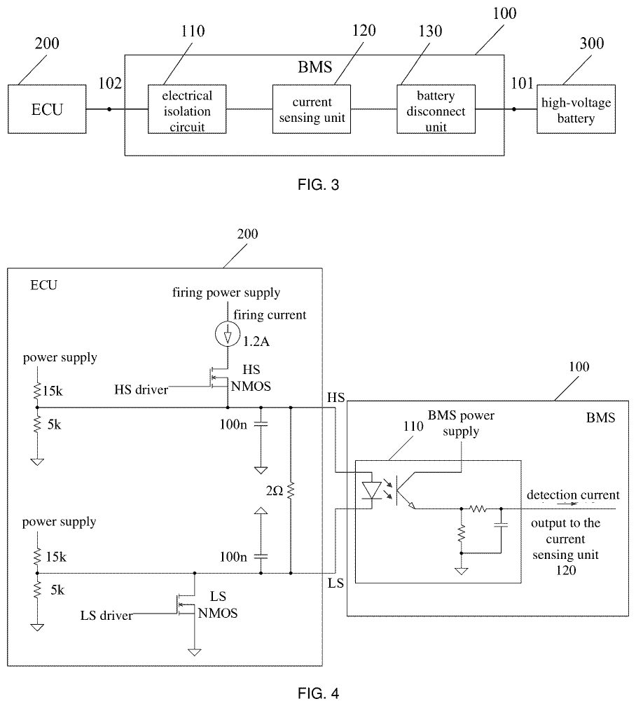

FIG. 3 is a schematic block diagram of a battery management system according to an example of the present disclosure.

As shown in FIG. 3, the battery management system 100 according to an example of the present disclosure comprises: a first terminal 101 connected to a high-voltage battery 300; a second terminal 102 connected to an electronic control unit 200; an electrical isolation circuit 110 configured to receive a first current from the electronic control unit 200 via the second terminal 102; a current sensing unit 120 configured to sense a second current output by the electrical isolation circuit 110 and generate a disconnect signal in response to the second current exceeding a first threshold value; and a battery disconnect unit 130 configured to disconnect the high-voltage battery 300 from a load (not shown) connected to the high-voltage battery 300 in response to the disconnect signal. According to an example the present disclosure, the electrical isolation circuit 110 comprises a photoelectric coupling circuit.

The use of a photoelectric coupling circuit may provide the electrical isolation circuit 110 with strong isolation and anti-interference capabilities.

As shown in FIG. 4, according to an example of the present disclosure, the input end of the photoelectric coupling circuit of the electrical isolation circuit 110 is connected to the second terminal 102 (i.e., the terminals HS and LS connected to the electronic control unit 200 shown in FIG. 4), and the output end of the electrical isolation circuit 110 is connected to the current sensing unit 120.

According to an example of the present disclosure, a photoelectric coupling circuit comprises a light-emitting diode and a photosensitive element optically coupled to each other.

According to an example of the present disclosure, the photosensitive element may comprise at least one of the following: a photoresistor, a photodiode, a phototriode, or a photocell.

In the example of FIG. 4, the photosensitive element is shown as a phototriode. One terminal of the phototriode is connected to the power supply of the battery management system, the other terminal of the phototriode outputs the detection current (i.e., the second current) to the current sensing unit 120, and the control terminal of the phototriode is optically coupled to the light-emitting diode.

According to an example of the present disclosure, in the event of a crash, the electronic control unit 200 applies a first current (i.e., a firing current) to the light-emitting diode via the second terminal 102. In response to the first current applied by the electronic control unit 200, the light-emitting diode emits a first light, and the first light emitted by the light-emitting diode causes the resistance state of the photosensitive element to change. For example, in response to the first light emitted by the light-emitting diode, the resistance state of the photosensitive element changes from a high-resistance state to a low-resistance state.

In the example of FIG. 4, when the light-emitting diode is not emitting light, the resistance state of the phototriode is in a high-resistance state, and the detection current (i.e., the second current) output via the phototriode has a first value; when the electronic control unit 200 applies the firing current (i.e., the first current) to the light-emitting diode via the second terminal 102, causing the light-emitting diode to emit light, the resistance state of the phototriode changes from a high-resistance state to a low-resistance state, and the detection current (i.e., the second current) output by the power supply of the battery management system via the phototriode has a second value higher than the first value.

According to an example of the present disclosure, in response to a change in the resistance state of the photosensitive element, the current sensing unit 120 senses a second current (i.e., a detection current) exceeding a first threshold value and generates a disconnect signal. According to an example of the present disclosure, the first threshold value may be set between a first value and a second value, i.e., first value<first threshold value<second value.

According to an example of the present disclosure, the current sensing unit 120 may comprise a differential current amplifier. Using a differential circuit may suppress ambient noise, thereby improving detection accuracy.

According to an example of the present disclosure, the current sensing unit 120 may further comprise any structure capable of detecting a second current (i.e., a detection current), and the battery disconnect unit 130 may comprise various structures capable of disconnecting the high-voltage battery 300 from a load connected to the high-voltage battery 300.

The battery management system according to examples of the present disclosure, through the electrical isolation circuit 100, eliminates electromagnetic compatibility issues such as bulk current injection (BCI) between the current sensing unit 120 of the battery management system and the electronic control unit 200. When the electrical isolation circuit 100 is composed of an electrical coupling circuit comprising a light-emitting diode and a photosensitive element, the light-emitting diode may convert the firing current (i.e., the first current) provided by the electronic control unit 200 into an optical signal, and then the photosensitive element may convert the optical signal provided by the light-emitting diode into an electrical signal again, for example, a detection current (i.e., the second current) that may be sensed by the current sensing unit 120. In this way, isolation is performed between the electronic control unit 200 and the current sensing unit 120.

It should be appreciated that the battery management system provided by examples of the present disclosure can be applied to various application scenarios requiring isolation, and is not limited to isolation between the electronic control unit 200 and the current sensing unit 120.

Examples of the present disclosure further provide a vehicle, comprising an electronic control unit, a high-voltage battery, and a battery management system according to various examples of the present disclosure. Vehicles according to examples of the present disclosure include, but are not limited to, electric vehicles (EVs), hybrid electric vehicles (HEVs), and plug-in HEVs (PHEVs).

Although the present invention has been particularly shown and described with reference to specific examples, it will be understood by those skilled in the art that various changes in form and details may be made therein without departing from the spirit and scope of the invention as defined by the appended claims. The scope of the present invention is therefore indicated by the appended claims and all changes that come within the meaning and range of equivalents of the claims are therefore intended to be embraced.

What is claimed is:

1. A battery management system, comprising:
a first terminal connected to a high-voltage battery;
a second terminal connected to an electronic control unit;
an electrical isolation circuit configured to receive a first current from the electronic control unit via the second terminal;
a current sensing unit configured to sense a second current output by the electrical isolation circuit and generate a disconnect signal in response to the second current exceeding a first threshold value; and
a battery disconnect unit configured to disconnect the high-voltage battery from a load connected to the high-voltage battery in response to the disconnect signal, wherein the electrical isolation circuit comprises a photoelectric coupling circuit.

2. The battery management system according to claim 1, wherein the input end of the photoelectric coupling circuit is connected to the second terminal, and the output end of the photoelectric coupling circuit is connected to the current sensing unit.

3. The battery management system according to claim 1, wherein the photoelectric coupling circuit comprises a light-emitting diode and a photosensitive element that are optically coupled to each other.

4. The battery management system according to claim 3, wherein the photosensitive element comprises at least one of the following: a photoresistor, a photodiode, a phototriode, and a photocell.

5. The battery management system according to claim 3, wherein the electronic control unit applies the first current to the light-emitting diode via the second terminal in the event of a crash;
in response to the first current being applied by the electronic control unit, the light-emitting diode emits a first light; and
in response to the first light being emitted by the light-emitting diode, a resistance state of the photosensitive element changes.

6. The battery management system according to claim 5, wherein, in response to a change in the resistance state of the photosensitive element, the current sensing unit senses the second current exceeding the first threshold value and generates the disconnect signal.

7. The battery management system according to claim 1, wherein the current sensing unit comprises a differential current amplifier.

8. A vehicle, comprising:
an electronic control unit;
a high-voltage battery; and
the battery management system according to claim 1.
